(19) United States
(12) Patent Application Publication
(10) Pub. No.: US 2012/0108412 A1
(43) Pub. Date: May 3, 2012

(54) APPARATUS FOR FOLDING FITTED SHEETS

(76) Inventor: Kenneth A. Alley, Tampa, FL (US)

(21) Appl. No.: 13/283,346

(22) Filed: Oct. 27, 2011

Related U.S. Application Data
(60) Provisional application No. 61/455,749, filed on Oct. 27, 2010.
(60) Provisional application No. 61/463,221, filed on Feb. 15, 2011.

(51) Int. Cl. B31B 1/26

(52) U.S. Cl. 493/405

(57) ABSTRACT

A folding apparatus controls the irregular corners and over all shape of a fitted bed sheet thus, enabling a fitted bed sheet to be neatly folded. The folding apparatus converts the irregular shape of a fitted sheet by providing a tool-template that controls each irregular corner section of the fitted sheet and by spooning each rounded corner of a fitted sheet onto one another.

### CROSS REFERENCE TO PRIORITY APPLICATION

This application claims priority under all applicable statutes to U.S. Provisional Patent Application No. 61/455,794 filed Oct. 27, 2010, and U.S. Provisional Application No. 61/463,221 filed Feb. 15, 2011.

### FIELD OF THE INVENTION

This invention relates generally to a solution to fold fitted sheets that are difficult to fold because of their overall size and or their irregular shapes. More particularly, the present invention is directed to an apparatus and method of folding fitted sheets.

### BRIEF DESCRIPTION OF THE PRIOR ART

There are two primary types of bed sheets: flat and fitted. A flat sheet is a rectangular sheet of cloth; as such, it is easily folded. A fitted sheet has a flat top section with cloth depending from the top section that is designed to encase a mattress on five sides leaving most of the bottom side of the mattress exposed. Elastic is usually sewn into the edges of the fitted sheet so that the fitted sheet fits snugly around the mattress and to prevent the fitted sheet from moving or slipping off the mattress. It is a very common problem to try to fold fitted sheets after they are removed from their original packaging or after laundering. The typical fitted bed sheet includes an elastic band at its outer edge that distorts its shape when the sheet is not on the mattress, and makes it difficult to neatly fold. The present invention provides is a novel solution that assists the consumer to easily fold fitted sheets and/or a geometrically irregular sheet.

In order to be useful as a consumer product, the apparatus that is the subject of this invention should be easy to use, physically small enough to be practical and, maybe most importantly, inexpensive. The ideal solution would be an invention that could be easily adapted to current manufacturing procedures, functions, assembly infrastructures and also one that can be adapted to existing fitted sheets (and or other bedding) as an aftermarket product. The invention must be simple to use, to integrate and instructionally easy to educate the consumer.

The subject invention consists of an aftermarket solution that could be marketed by means of direct television, infomercials, and typical retail. Also described is an alternative concept that can be adapted into the original manufacturer's process and built into future bedding, sheets etc.

The irregular rounded shape of a fitted bed sheet makes it difficult to fold. Many people admit to just rolling up fitted sheets into a ball and storing it out of sight in a closet. The issue has become so acute, that numerous instructional documents to teach consumers how to fold a fitted sheet have been developed. In addition, numerous videos have popped up on the internet to teach people how to fold a fitted sheet. It is a well recognized problem and worthy of a practical solution. The present invention provides a solution to help fold a fitted sheet with ease and in a fraction of the time it would if one tries to follow some instructional document. The descriptions and figures disclosed herein are examples of some of the preferred embodiments. There are numerous shapes and alternative designs that could be adapted to the present invention.

Relatively simple solutions have been developed to fold clothing such as flip and fold systems that are designed to fold shirts and other clothing. Automated mechanical systems have also been developed to mechanically fold sheets and other materials. For example, U.S. Pat. Nos. 5,624,366 and 6,006,065 are two examples of mechanical devices developed to fold sheets.

The folding means that is the subject of this invention is a novel approach to solving a very common and recognized problem of folding a fitted sheet at home. The expensive robotic and template folding mechanisms previously developed are too large and too expensive for a good home solution. There needs to be a more functional, simple and practical solution to address the common problem of folding fitted bed sheets.

Alternate means have been developed to address the folding problem of the sheets. For example, U.S. Pat. No. 7,761,940 B2 Hipp, describes corner components adapted to bed sheets, other products are sold that require attaching permanent buttons to the inside corner of fitted bed sheets unlike. In contrast, U.S. Provisional Application No. 61/455,794 dated Oct. 27, 2010 Alley teaches that one cannot control and conform a fitted sheet into a rectangular shape by simply buttoning the four corners (as sold as an aftermarket product) of a fitted sheet together. Alley teaches that the corner sections need to be buttoned in a fashion to square off each individual corner and then, the sheet can be buttoned or folded once converted to a rectangular shape.

### SUMMARY OF THE INVENTION

The present invention is a handheld device that is and used by the consumer to fold fitted sheets and does not become permanently attached to the bed sheet. The apparatus is a tool/template that is used for folding the fitted sheet. The apparatus could be designed to hang over a door or attach to a stand if desired. The apparatus is currently brand named by Alley, as the “Folding Wand™”).

The present invention converts the irregular shape of a fitted sheet by controlling the irregular corners of the fitted sheets. The ideal way to fold a fitted sheet is to spoon each of the corners into each other. This will keep the folded sheet as neat and the least bulky as possible when folding it. The Folding Wand creates a template to slide each sheet corner seam of a fitted sheet onto the apparatus thus, controlling the irregular shape of the fitted sheet to a manageable shape which is easy to fold.

A typical fitted sheet includes a top section and a skirt section, each corner of a fitted sheet is formed where the top section is connected to two sides of the skirt section thus, creating a corner section (x, y, z axis) and a seam line.

The present invention provides means to control each corner section by providing means to attach each corner section of the fitted sheet onto and on top of each other corner section. This controls each corner section (which is naturally rounded) and forms a new corner where each of the rounded corners are layered onto and into each other (by spooning) to form a single rounded or squared off corner. The present invention includes an opening that the fitted sheet seam can slide into, to assure proper placement for each corner section. The present invention also includes rounded tips that control the placement of the folding wand relative to the fitted sheets skirt length, thus assuring proper positing of the folding wand in all axes. Once the corner sections of the fitted sheet are all attached to the folding wand (apparatus), the fitted sheet will be substantially square or rectangular in shape. At this point the folding wand can be removed and the sheet can easily be folded, as desired.

### BRIEF DESCRIPTION OF THE DRAWINGS

The accompanying drawings, which are incorporated in and form a part of the specification, illustrate the embodiments of the present invention and, together with the following description, serve to explain the principles of the invention. For the purpose of illustrating the invention, there are shown in the drawings embodiments which are presently preferred, it being understood, however, that the invention is not limited to the specific instrumentality or the precise arrangement of elements or process steps disclosed.

In the drawings:

FIG. 1 is a side perspective view of a Folding Wand (apparatus).

FIG. 2 is a side perspective view of an alternative configuration of the Folding Wand (apparatus).

FIG. 3 is an isometric perspective view of the Folding Wand (apparatus).

FIG. 4 is a back perspective view of the Folding Wand (apparatus).

FIG. 5 is a bottom view of the Folding Wand (apparatus).

FIG. 6 is an alternative design referred to as the Folding Square (apparatus).

FIG. 7 is an alternative design referred to as the Folding Arch (apparatus).

FIG. 8 is a side view of the folding arch apparatus of FIG. 6, with a hanging system that can be attached to a door (wall or stand).

FIG. 9 is an alternative apparatus consisting of a Rib-like feature (Spooning Arch) that could be permanently attached to fitted sheets.

FIG. 10 is an illustration view of a typical fitted sheet. The illustration specifies a fitted sheet corner section, skirt and seam

### DETAILED DESCRIPTION OF THE PREFERRED EMBODIMENT

In describing a preferred embodiment of the invention, specific terminology will be selected for the sake of clarity. However, the invention is not intended to be limited to the specific terms so selected, and it is to be understood that each specific term includes all technical equivalents that operate in a similar manner to accomplish a similar purpose.

The terms “right”, “left”, “top”, “bottom”, “lower” and “upper” designate relative directions in the drawings to which reference is made.

The preferred embodiments of the present invention will now be described in detail with reference to the accompanying drawings in which a novel apparatus 20 is described.

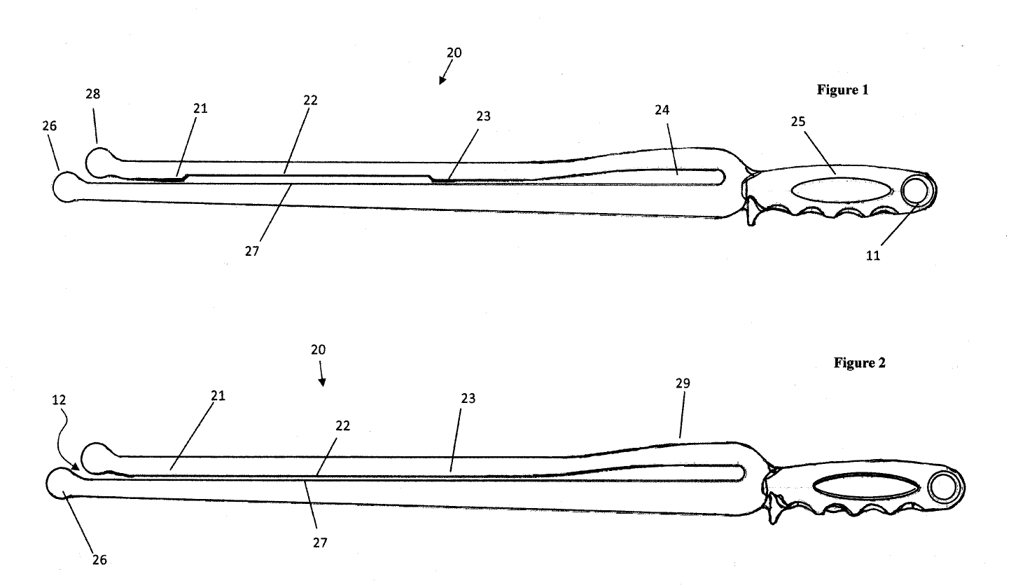

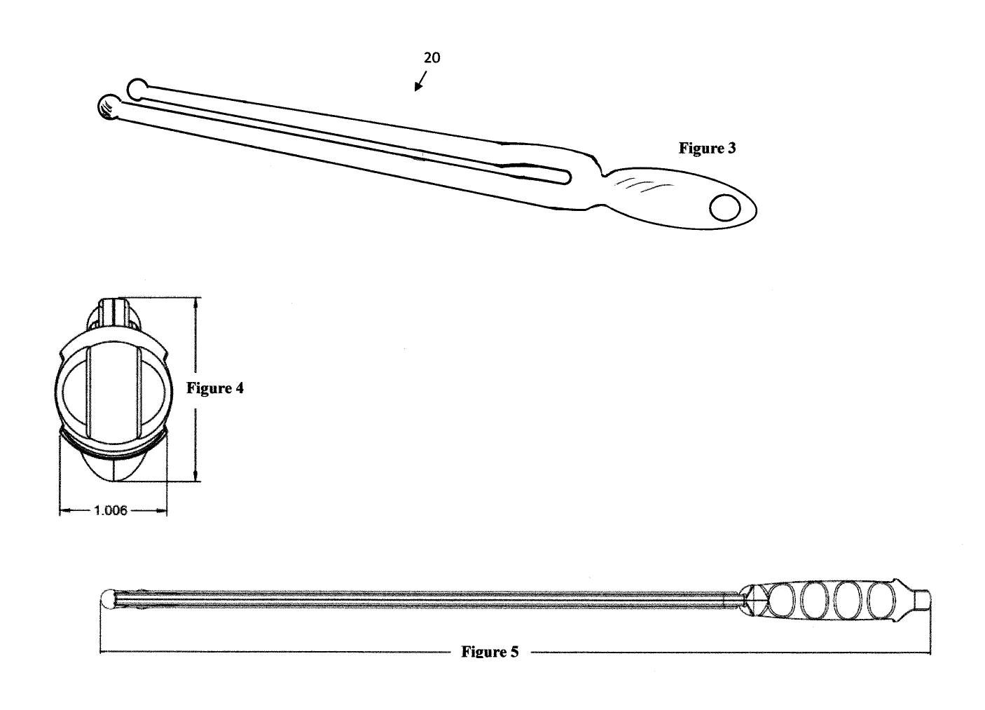

Now referring to FIG. 1, is a side view of the apparatus 20 that is the subject of this invention. The present invention (sometimes referred to as the folding wand) 20 includes rounded buttress tips 26, 28 which are used to guide the fitted sheet onto the sheet-folding apparatus 20. Rounded buttress tips 26 and 28 are shaped to easily guide the sheet seam onto the lower guide section 27 of sheet-folding 20.

U.S. Provisional Application No. 61/455,794 dated Oct. 27, 2010, to Kenneth Alley teaches a method which includes buttons and/or snaps that are located in such a way not to interfere when the sheet is in use but, allows the fitted sheet corners to be buttoned in such a way to square off the corner sections making it easy to fold. A simplified version is to include a fitted sheet that you button together to fold. These buttons could be designed into future fitted sheets during manufacturing or added as an aftermarket feature. U.S. Provisional Application No. 61/455,794 is incorporated by reference as if fully set forth herein.

U.S. Provisional Application No. 61/463,221 dated Feb. 15, 2011, to Kenneth Alley discloses a tool that is used just for folding the fitted sheet, it may or may not remain with the fitted sheet until it is placed onto a bed referred to as the “Spooning Arch”. Also, later described, a version of the “Spooning Arch” could be adapted to become permanently part of a future fitted bed sheet. At that time of the filing, it was desired to use an arch like device. In this application Alley teaches an apparatus to control the corner sections of a fitted sheet that converts the irregular shape of a fitted bed sheet into a controlled rectangular shape that is easy to fold. U.S. Provisional Application No. 61/463,221 is incorporated by reference as if fully set forth herein.

As a fitted sheet is placed onto the Folding Wand so that the lower buttress 26 will engage the X-Y-and X axis of the fitted sheet. This is where the three sides of the fitted sheet meet and form a corner point (Refer to FIG. 10, Notes). After the first corner section is slid onto apparatus 20, buttress tip 26 will be underneath the sheet out of sight. Buttress tip 28 will provide a guide to slide the remaining corner sections onto apparatus 20. The apparatus 20 includes lower section 27 which is designed to geometrically fit standard size fitted sheets. Specifically, the skirt length of fitted sheets and the thickness of materials may vary so the lower guide section 27 communicates with upper guide section 22. Upper guide section 22 may include features 21 and 23 that may provide slight pressure on the fitted sheet seams as they are positioned onto the apparatus 20 by narrowing the space between upper guide arm 22 and lower guide arm 27. Special features 21 and 23 may include guides to help position the seam through the center of the lower and upper sections of apparatus 20. Features 21 and 23 may also be designed to be flexible. Upper guide section 22 and lower guide section 27 includes a larger gap 24 between both upper and lower guide sections of apparatus 20. This gap 24 is designed to take up the excess material of larger fitted sheets and or thicker materials. This gap 24 will also allow easy removal of the folding wand after the sheet has been configured into a nice controlled rectangle. Apparatus 20 also includes an ergonomic handle 25 that positions the weight load of the fitted sheet in the same plane as the wrist to minimize strength required to hold the sheet. Apparatus 20 also includes opening 11 to provide means to hang apparatus when not in use. Referring to FIG. 2, apparatus 20 includes flexible geometry 29 thus providing means to maintain slight downward pressure of upper section 22 against lower section 27. Flexible geometry 29 can replace or augment features 21 and 23 by maintaining enough pressure between lower and upper sections 27 and 22 respectively, as each sheet seam is placed onto the apparatus 20.

There are multiple ways to use the apparatus to fold a fitted sheet. For example, the fitted sheet can be attached to apparatus 20 by attaching each corner separately/individually or the fitted sheet can be folded once in half, thereby aligning each elastic corner and seam before attaching the fitted sheet to the apparatus 20.

To attach each corner section separately (one corner at a time) the procedure is as follows:

Optional: Preparation of the fitted sheet is optional although, it will help keep things neat and easier until you get the hang of it.
Prepare the sheet so that the underside of the sheet and the corner sections are all facing upward. The sheet will be concave, the same way you put it on the bed but upside down. Referring to FIG. 2,
STEP 1—With the Folding Wand™ apparatus 20 in the right hand (if right handed), insert a skirt sheet seam of the fitted sheet (Refer to FIG. 10) into the groove opening 12 of the Folding Wand until the rounded tip 26 of the Folding Wand is positioned against the inside corner of the fitted sheet.
STEP 2—Slide your left hand along the sheet to the adjacent left sheet corner and repeat step 1, thus inserting the skirt sheet seam into grove opening 12 of the Folding Wand and on top of the first seam until the sheet corner is snuggly against the rounded tip 26 of the Folding Wand. At this point you will have two corners attached to the Folding Wand. Note: If left handed you would grab the adjacent right sheet corner and keep the Folding Wand in the left hand.
STEP 3—Simply reach forward and insert the upper 3rd corner seam (upper most seam) onto the Folding Wand thus into grove opening 12 of apparatus 20 (over top the other seams) and finally place the 4th corner seam over the others. At this point it is easy to tidy things up by making sure the sheet ends coming off each side of the Folding Wand are even and straight. Note: The upper 3rd corner seam (upper most, seam) is easier to locate if you follow the sheet edges coming off the Folding Wand apparatus 20.
STEP 4—The Folding Wand still in your right hand, take your left hand and grab the left corner of the fitted sheet to form a rectangle. By pointing the Folding Wand upward and outward, you will have a nice and neat rectangle which you can fold as desired. Place the Folding Wand with the sheet attached onto a table and then the Folding Wand can be slid off the sheet by grabbing the sheet corners attached to the Folding Wand and sliding the Folding Wand off. Then fold the fitted sheet as desired.

A second approach to folding a fitted sheet using the apparatus 20 is to first fold the fitted sheet in half as follows:

Hold the elastic corners of the sheets skirt and fold the sheet in half Make sure the corners and the skirt seams are neatly aligned. Then lay the sheet on a flat surface.

With the Folding Wand in the right hand (if right handed), insert both; the top and bottom sheet, at the corner seams into the groove opening 12 of the Folding Wand™ until the rounded tip 26 of the Folding Wand is positioned firmly against the inside corner section (skirts length) of the fitted sheet (Refer to FIG. 10, Notes). Then, with your left hand, grab the left side corner seams and fold it over the right side of the fitted sheet and repeat Step 2, thus inserting the remaining 2 corner seams into the grove opening 12 of the Folding Wand and over top of the first two seams until the rounded tip 26 of the Folding Wand™ is positioned firmly against the inside corner sections of the fitted sheet. At this point, all 4 corner seams are attached to the Folding Wand. Finally, the Folding Wand (apparatus 20) still in your right hand (pointing upward) take your left hand and grab the left corner area of the fitted sheet to form a neat rectangle. By pointing the Folding Wand upward and outward, you will have a nice and neat rectangle which you can fold as desired.

Place the Folding Wand with the sheet attached onto a table, the Folding Wand can be slid off the sheet corners by grabbing the “4 sheet corners” attached to the Folding Wand with one hand while sliding the Folding Wand off of the sheet. Then fold the fitted sheet as desired.

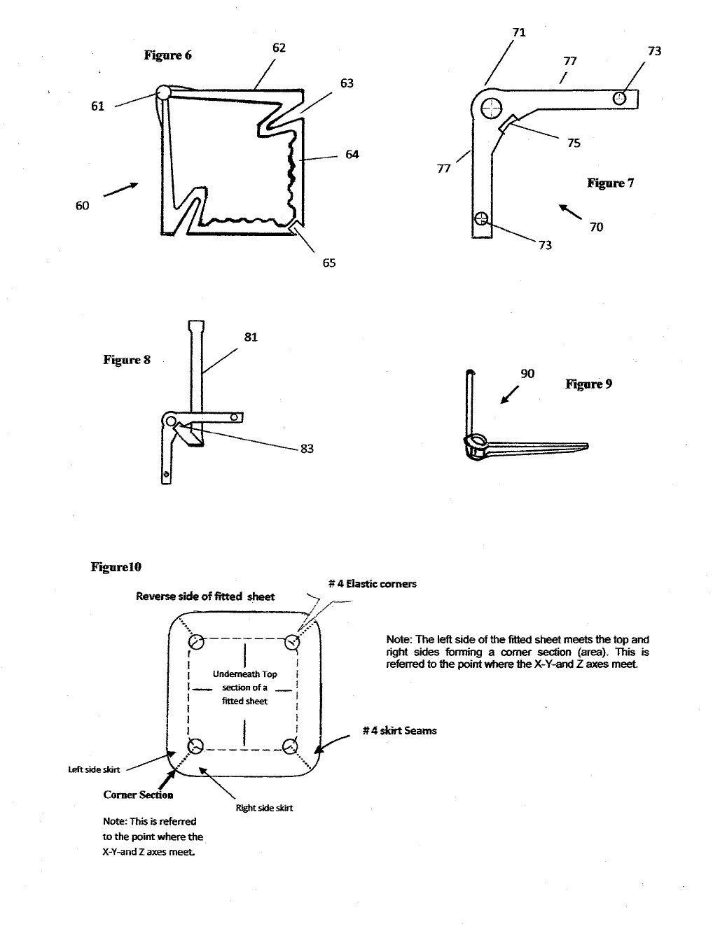

Now referring to FIG. 6, an alternative embodiment referred to as the Folding Square (apparatus) 60. The Folding Square works very similar although, it does not require a groove or opening to slide the seam of the fitted sheet into. Instead the sheets corner seam is just placed over the Folding Square. The Folding Square acts more like a template which is easier to handle on larger sized sheets. The Folding Wand and Square (and the Arch in FIG. 7) configurations include rounded buttress tips that locates and orients the folding device in the proper position during use. The rounded tip/ball shaped buttress intersects all three axes of the fitted sheet. In both cases, the Wand and the Square are controlling the X-Y-Z axis or at least one of these axes to square (or round) off and control the corner sections as the sheet as it is folded. Similar to the function of the apparatus 20 the folding square includes rounded tip buttress 61 that provides a guide to position each corner section of a typical fitted sheet (as illustrated in FIG. 10, Notes). Apparatus 60 includes upper frame guide 62 over which the fitted sheet's seams are placed. When placing each seam over the guide 62, the fitted sheet's corner sections automatically become interlocked into each other, thus turning each corner section into a concave shape wrapped (spooning) around the guide 62. Apparatus 60 also includes groove 63 that provides a space to control excess material from larger sheets. Handle 64 provides a lever arm that minimizes the load/weight on a user's wrist by allowing the user of the apparatus to hold the weight of the sheet by one leg of a triangle versus the apparatus 20 design. Apparatus 60 maybe designed symmetrically so that it may be used by both right and left-handed people. Apparatus 60 may also include a connector feature 65 that would provide means to attach it to a holder or door mounted (shown in FIG. 8) or table mounted mechanism etc. also taught by Alley described in U.S. Provisional Application No. 61/455,794 dated Oct. 27, 2010. Referring now to FIG. 7 which is an alternative embodiment (folding tool template) referred to as the Folding Arch apparatus 70. Apparatus 70 works similar to the other previously described folding apparatuses. Folding Arch 70 can be held by one of the guides 77 to use the apparatus in a hand held mode, or attachment means 75 can be used to make the arch a hanging system as illustrated in FIG. 8. Hanging apparatus 81 with attachment mean 83 can be used to fit into apparatus 70 hanging feature 75. Also included are sheet holding features 73 which can be used to temporarily assist in keeping the sheets neatly attached to the folding arch during use. These features may include flexible fingers that apply friction to hold the sheet in place as each sheet corner section is inserted over the rounded buttress 70. Once all four corners are placed over the Folding Arch 70 (or Square 60 if hanging feature 65 is utilized), the irregular shape of the fitted sheet will be converted to a manageable rectangular shape that can be removed off apparatus 70 and the sheet can then be folded as desired.

Referring now to FIG. 9 an alternative embodiment consisting of a rib-like feature (Spooning Arch) that could be permanently attached to fitted sheets or a sleeve-like pocket could be designed into future fitted sheets. Apparatus 90, rib-like feature could be added and remain as part of a fitted sheet. The rib-like feature 90 could be flexible, foldable or designed with a living hinge and or designed to attach to a corner section without a sleeve.

FIG. 10 is an illustration view of a typical fitted sheet. The illustration specifies a fitted sheet corner section, skirt and seam. The folding wand apparatus 20 includes groove opening 12 that separates the lower guide section 27 and upper guide section 22. The elastic corners of a fitted sheet are placed into or onto the lower guide section 27 along the fitted sheet seams. Additionally, the lower guide section includes a rounded top 26 that is positioned opposite the elastic corner. This position is referred to the corner section of the fitted sheet where the x, y and z axes meet (the left side skirt of the fitted sheet meets the top and right side skirt forming a corner section and a seam line).

Although this invention has been described and illustrated by reference to specific embodiments, it will be apparent to those skilled in the art that various changes, modifications and equivalents may be made which clearly fall within the scope of this invention. The present invention is intended to be protected broadly within the spirit and scope of the appended claims.

I claim:

1. An apparatus for folding fitted sheets comprising:
a handle;
two elongated rods attached to the handle that extend in close proximity and substantially parallel to each other away from the handle.

2. The apparatus of claim 1 wherein the two elongated rods are in such close proximity that a fitted sheet inserted between said two elongated rods would engage both rods.

3. The apparatus of claim 1 wherein at a position proximate the handle, the elongated rods form a gap.

4. The apparatus of claim 1 further comprising buttress tips on each end of said two elongated rods opposite the handle.

5. The apparatus of claim 1 further comprising a means in the handle to hang said apparatus (such as on a wall or door) on a vertical surface.
